(19) United States
(12) Patent Application Publication
(10) Pub. No.: US 2016/0116310 A1
(43) Pub. Date: Apr. 28, 2016

(54) SMART WIRELESS LOGGERS

(71) Applicant: CONTROLANT EHF., Reykjavik (IS)

(72) Inventors: Erlingur Brynjúlfsson, Reykjavík (IS); Gísli Herjólfsson, Kópavogur (IS)

(73) Assignee: Controlant ehf, Reykjavík (IS)

(21) Appl. No.: 14/786,513

(22) PCT Filed: Apr. 22, 2014
(86) PCT No.: PCT/IS2014/050005

§ 371 Date: Oct. 22, 2015

(30) Foreign Application Priority Data
Apr. 22, 2013 (IS) 050052

(51) Int. Cl. G01D 9/00; G06Q 10/08

(52) U.S. Cl. CPC G01D 9/005; G06Q 10/0832; H04W 84/18

(57) ABSTRACT

The present invention relates to a device and system for making automatic and on-line supply-chain monitoring in both small and large distribution networks possible. Moreover, the present invention provides a simple and economical method with wireless loggers to build up a usually expensive and complicated infrastructure for cold-chain monitoring.

### FIELD OF THE INVENTION

The present invention relates to a device and method for making automatic and on-line supply-chain monitoring in both small and large distribution networks possible. Moreover, the present invention provides a simple and economical method with wireless loggers to build up a usually expensive and complicated infrastructure for supply-chain monitoring.

### BACKGROUND OF THE INVENTION

For safety and regulatory reasons, amongst others, the need to monitor products is increasing rapidly in industries such as, the food, pharmaceutical, recycling and life science industries.

In the modern logistical environment, where the emphasis on quality of conditions and handling during shipment is increasing, players in the field have to cope with more investment in technology and time of employees to meet those requirements. As the devices become more automatic, they save more time, which leads to lower cost and better service. With proper overview and robust and smart hardware, these automatic solutions can offer the possibility to monitor a greater amount of shipments than before. A key factor in making such systems automatic is to ensure that regularly occurring incidents are dealt with—such as shipments that take longer time to be delivered than anticipated, poor GPS reception, faulty hardware etc.

Solutions for monitoring a product throughout the distribution chain (i.e. from manufacturing through distribution to resale) have been used for a long time. Those solutions, most commonly used, are mainly offline in such that they do not provide the user with automation for delivery of data, once the shipment is at its destination location or on any other parts of the products rout. They, therefore, require the user to offload data in a manual manner, by connecting the device to a computer, generating a report and sending it to the provider.

Such procedures, involving user handling, may be inaccurate, slow and error prone. In many cases these kinds of procedures may even require the user to send the logger to the provider of the monitored product where feedback would be needed from the provider for handling to be continued, adding a large delay to the handling procedure.

In the modern world, increased emphasis is put on the quality of goods which are offered to customers. On top of that, stakeholders want to know more about processing, transportation and storage of a product during its lifespan. Producers, resellers, distributors, buyers, consumers, transportation companies, insurance companies and other stakeholders all have benefits, although it may vary, of more accurate and more “on-line” traceability of products.

An “online” wireless and automatic system would provide customers with a way to reduce delay, errors and reduce cost of monitoring. Such a system may, however, be a more expensive option, compared to the standard solutions. One of the main thresholds for the use of such a system lies in the cost to rollout and maintain and operate the infrastructure needed throughout the distribution network.

By logging environmental conditions during transportation, preventive action can be executed to improve safety of products in a distribution network. By offering on-line monitoring of products during transportation, incidents and deviations can be acted upon as soon as they happen. Such systems are expensive and not feasible for large scale distribution network applications.

In global logistical environments, off-line loggers have been used for years. Recently, as wireless technology has gradually been introduced to many sectors, interest has risen in using automatic and real-time loggers to reduce time and cost associated with monitoring conditions of shipments. It is also of interest to get information on products and assets being shipped in time to make important decisions in real-time, rather than waiting for the logger to arrive to its destination location.

That introduces issues, which need to be addressed, so automation can fully be utilized. It is important that environmental loggers gather data for a long time without losing the battery charge necessary to operate. They furthermore need to be able to securely off-load the measurements at the destination location, for users to analyse the data and make decisions based on that data, when conditions are not ideal. Such conditions might be if cellular network connection is bad or if the logger has finished its battery charge for real-time access to the centralized system. For full automation in such solutions, the system must validate if the logger has arrived to its intended destination location. Doing such a validation either requires manual work or high cost infrastructure.

### SUMMARY OF THE INVENTION

The present invention provides a device and a system to make on-line monitoring of products throughout a distribution network utilizing an external wireless network connection, i.e. GPRS, 3G etc.

To ensure robustness of logging the wireless active logger of the present invention has separate functionality when it comes to measuring and communicating. While it is shipping, it will provide a real-time access to temperature and location data. During that time, it will be powered by a rechargeable battery, which is capable of providing regular communication over the internet via a cellular network connection. This allows the user to have access to the data whenever the logger is within range of a cellular network. As the cellular network communication takes up quite a lot of power, the logger will only be able to operate in that mode for a number of days or weeks, rather than months. In cases where loggers take longer to be delivered, or the rechargeable battery has less capacity, the logger might lose power before the delivery of the shipment. The wireless active logger of the present invention uses a separate circuit, powered by a separate long-life/low-power battery, for recording measurements into memory. This will make sure that all measurements can be stored in the logger independent of how much capacity is found in the rechargeable battery.

The long-life/low-power battery will also power a short range communication module, which makes the logger able to communicate measurements (i.e. temperature and location) through a transceiver located at the destination location or anywhere on the route of the shipment. This gives the logger an important alternative to offload data, still in an automatic way.

The present invention relates to a device and method to make automatic and on-line supply-chain monitoring in both small and large distribution networks possible where wireless loggers can be used to build up a usually expensive and complicated infrastructure for such behaviour in an easier and more economical way.

The provided wireless active logger offers robustness and safety of low-power off-line loggers along with wireless, automatic and real-time functionality during transport of goods, both short and long distances in a global environment, between countries as well as between continents. The logger will log data collected by a sensor during transport and communicate measurements and other data regularly to a centralized system, while it is connected to a network and has a charge on the rechargeable battery. Once the logger arrives to its destination, it will send measurements, location information and other data using the external module. The centralized system will get delivery verification if there is already a transceiver on the destination location. That transceiver can furthermore be used to deliver data, in case there is no communication or charge for the external module to do the job. In case there is no transceiver at the destination location and the external module cannot communicate with the network, either due to no network connection or an empty or flawed rechargeable battery, the logger can be connected to a computer via a computer connector (i.e. USB) at a later stage to collect the data. This way, it can transmit measurements and other data to the centralized system through the computers network connection. Furthermore, the logger can be left at the destination location and connected to a computer to serve as a transceiver using the computers power and network connection to operate and communicate data. In case where the computer loses its network connection or power, safety is ensured as the logger will use the external module to maintain power and network connection during the outage.

The logger comprises of;
a. An internal low power measurement module for operating in low-power mode for years, collecting measurements continually, i.e. with an interval of some seconds or minutes, and makes the logger able to communicate in low-power mode through a network connected transceiver in the vicinity of the logger.
b. External real-time communication module, operating on a rechargeable battery and communicating through a network (GPRS or similar connection) allowing the logger to communicate measurements and other data to a centralized system in real-time, whenever it has charge on the rechargeable battery and it is in communication with a network.
c. Computer connector which enables the logger to communicate its data to the centralized system via the computer network connection, i.e. if the logger has run out of battery charge. It furthermore makes the logger able to function as a transceiver which can communicate data from other loggers to the centralized system and offer delivery verification. When the logger is being used as a transceiver, it will use power from the connected computer and its network connection to operate and deliver data to the centralized system. If the computer loses its network connection or power, the logger/transceiver will use its external communication module and rechargeable to maintain power and network connection thereby providing a desirable and important redundancy in the infrastructure.

In a first aspect of the present invention a wireless active logger device is provided for measuring and storing information on environmental conditions during transportation of goods. The device comprises an internal low power module further comprising a memory, a processor, a sensor, an internal wireless network module and a long-life/low-power battery. The device further comprises an external module comprising a memory, a rechargeable battery, a charging circuit, an external network module and a processor. The device also comprises means of internal communication between the two modules and means of communicating with a computer. The device is characterised in that the internal low power module continuously logs data from the sensor and sends the data to a centralized system through the external module, when the external module is in communication with a wireless network.

In a second aspect of the present invention a system is provided for measuring and storing information on environmental conditions during transportation. The system comprise providing a wireless active logger, said wireless active logger further comprising an internal low power module further comprising a memory, a processor, a sensor, an internal wireless network module and a long-life/low-power battery. The device further comprises an external module comprising a memory, a rechargeable battery, a charging circuit, an external network module and a processor. The device also comprises means of internal communication between the two modules and means of communicating with a computer. The device is characterised in that the internal low power module continuously logs data from the sensor and sends the data to a centralized system through the external module, when the external module is in communication with a wireless network.

### DETAILED DESCRIPTION OF PREFERRED EMBODIMENTS

The following definitions and embodiments relate to the device and the system of the present invention.

In an embodiment of the present invention the internal low power module continuously logs data from the sensor after the rechargeable battery has run out.

In an embodiment of the present invention the wireless active logger sends the data to a centralized system through the external module while the rechargeable battery has charge.

In an embodiment of the present invention the wireless active logger communicates with a transceiver at a destination location via the internal low power module to verify that it has arrived to the destination location, or to communicate measurements and other information to the centralized system.

In an embodiment of the present invention the wireless active logger can be connected to a computer at the destination location to communicate data from the logger to the centralized system in case of failure in the device, connection problems or low battery charge, and/or serve as a transceiver.

In an embodiment of the present invention the wireless active logger communicates wirelessly with a transceiver when it is in the vicinity of such a transceiver.

In an embodiment of the present invention the external wireless network module communicates stored data from the wireless active logger it is housed in and collects and communicates wirelessly stored data from other wireless active loggers in the vicinity of it for which it serves as a transceiver.

In an embodiment of the present invention the wireless active logger initiates communications with the centralized system through its external wireless network module only when the sensor detects environmental measurements out of set measurement limit for the environmental conditions.

In an embodiment of the present invention the wireless active logger is powered by the computer connector when it is plugged into a computer before, during or after shipment is completed.

In an embodiment of the present invention the computer software is used for communicating data from the wireless active logger through a computer connector to a centralized system via a network connection. The computer software can be stored in the wireless active logger and can be accessed from there by the computer through the computer connector. The computer software can also be stored on the computer into which the wireless active logger is connected to for communicating the data to the centralized system. Furthermore, the software can provide a unique location identification number which the centralized system uses to identify from which location data is being sent.

In an embodiment of the present invention the wireless active logger will not use its external wireless network module to communicate with a centralized system when the wireless active logger is in the vicinity of an active transceiver.

In an embodiment of the present invention the wireless active logger does not collect data from other wireless active loggers in the vicinity of itself if it cannot establish a connection or re-establish a lost connection to the centralized system.

In an embodiment of the present invention the external wireless network module initiates communication with the centralized system before, during and after transportation if the wireless active logger is in the range of wireless network coverage, including but not limited to GPRS, 3G etc.

In an embodiment of the present invention the wireless active logger is used to measure and log into memory data on environmental conditions during shipment/transport of a product and either delivers data wirelessly through a transceiver or via data connection to a network connected computer or via an embedded external wireless network module.

In another embodiment of the present invention, the wireless active logger is connected to a computer to both deliver data stored in its memory to a centralized database system, and to serve as a transceiver for other wireless active loggers which are expected to need to communicate their data wirelessly through a transceiver to the centralized database system.

In an embodiment of the present invention the device communicates with a computer by user in software accessible to users from a network (i.e. the internet, VPN etc.), from the logger itself (where software is installed directly from the logger) or by other medium (i.e. floppy disk, USB storage, CD, DVD etc.)

In an embodiment of the present invention the device is equipped with an external wireless network module, i.e. GPRS, 3G or other wireless network connection, to transmit data from itself and other wireless active loggers in the vicinity to the centralized database system, issue events, warnings and more, providing on-line real-time monitoring of goods during transportation. Once at a location, the wireless active logger can in hand communicate with the centralized database system through an internet connection computer, but also able to communicate through a wireless connection which adds significantly to redundancy.

In an embodiment of the present invention, the wireless active logger is equipped with a rechargeable battery and a charging circuit. The wireless active logger uses the rechargeable battery when it uses the external wireless network module to communicate with the centralized system.

In an embodiment of the present invention, the rechargeable battery is recharged once it is connected to a computer through its computer connection (i.e. USB, FireWire etc.).

In an embodiment of the present invention, the wireless active logger sends event, text message, email or other form of messages in the event of shipment content going out of desired environmental range.

In an embodiment of the present invention, the wireless active logger sends event, text message, email or other form of messages in the event that a shipment arrives at its destination location or other locations of interest in the distribution chain.

In an embodiment of the present invention the wireless active logger, equipped with an external wireless network module, does not try to communicate directly with the centralized system if it is in the vicinity of a transceiver (i.e. located in a vehicle or at a location) which is communicating with the centralized system. Instead it will operate on its long-life/low-power battery to communicate data to the transceiver.

In an embodiment of the present invention the wireless active logger can both send data to the centralized system through a network connected computer and through a wireless network connection when the device is equipped with such in the event that either communication method fails.

In an embodiment of the present invention the computer connector is a data and power connection to a computer via USB connector, FireWire connecter or a wireless connected dock station.

In an embodiment of the present invention the sensor detects environmental conditions such as temperature, humidity and light intensity.

In the present context the term “internal wireless network module” refers to a communication module which has the purpose of handling communication of environmental data log and other information between sensors and transceivers. These communications use low power and require only a “long-life battery” to operate for a long time.

In the present context the term “external wireless network module” refers to a communication module which has the purpose of communicating data wirelessly (i.e. GPRS, Wi-Fi, 3G etc.) from a transceiver or a sensor to the centralized system through a network (i.e. Internet, VPN etc.). This module uses more power than the “internal wireless network module” and, thus, requires a more powerful battery to ensure normal operation. Loggers equipped with an external network module are equipped with a rechargeable battery and a recharging circuit.

In the present context the term “rechargeable battery” refers to a battery or another portable power source which can provide enough power for the present invention to communicate through a wireless network (i.e. GPRS, Wi-Fi etc.). Although it is referred to as a “rechargeable battery”, a single use battery could be used instead.

In the present context the term “means of communication” or “means of internal communication between the two modules refers to communication means such as, but not limited to digital port, serial ports, cables etc.

In the present context the term “perishable goods” refers to products which value and/or quality decreases when environmental conditions go out of certain boundaries, which may vary between products.

In the present context the term “offline logger” refers to a wireless active logger which logs measurements of environmental conditions to memory for storage. The logger is not wireless and, therefore, needs to be connected to a computer to offload data to be analysed or sent via email or by other means. No wireless automation is in the offload of data.

In the present context the term “on-line loggers” refers to loggers which can be connected to a centralized database throughout transportation from the time it is packed and shipped, throughout distribution and to delivery, or only at the destination location.

In the present context the term “container” refers to something containing one or more products before, during or after shipment, i.e. box, package, bag etc.

In the present context the term “wireless active logger”, “wireless logger” and “wireless sensor” refers to devices having a sensor to measure environmental conditions which are of relevance to the user and/or the system. The wireless active logger logs measurements into memory, communicates and transmits logged measurements to a centralized online database through a transceiver, once he is in range for wireless communication. The device can furthermore serve as a transceiver for other wireless active loggers in the vicinity of it either if equipped with an external wireless network module or when connected to a network connected computer, equipped with software.

In the present context the term “location” refers to a physical location of some meaning in a distribution network. The location can be an origin, destination or intermediate location for goods. The location may or may not be equipped with wireless infrastructure.

In the present context the term “destination location” refers to a location where an item is left after transport.

In the present context the term “computer connector” refers to a data and power connection to a computer via, including but not limited to, USB connector, FireWire connecter, a wireless connected dock station etc.

In the present context the term “probe” or “environmental sensor” refers to a circuit on the sensor/device which measures environmental conditions (including but not limited to temperature, humidity, light intensity etc.) a once the processor requires it to do so.

In the present context the term “long-life/low-power battery” refers to a battery used in the wireless active logger to keep it running for a long time. The long-life/low-power battery is used for standard operations during normal operation mode, such as taking measurements, sending data wirelessly and more and is capable of powering a low power device for a long time (for a number of months or years).

In the present context the term “validation of delivery” refers to a process carried out by a transceiver and the centralized system to detect and validate that a shipment with a logger associated to it is at its destination location and can therefore be deemed as delivered.

In the present context, the term “transceiver” refers to a device which can communicate wirelessly with wireless loggers, collect data from said loggers and transmit them to a centralized system.

### DETAILED DESCRIPTION OF PREFERRED EMBODIMENTS

The invention will now be described in relation to the drawings.

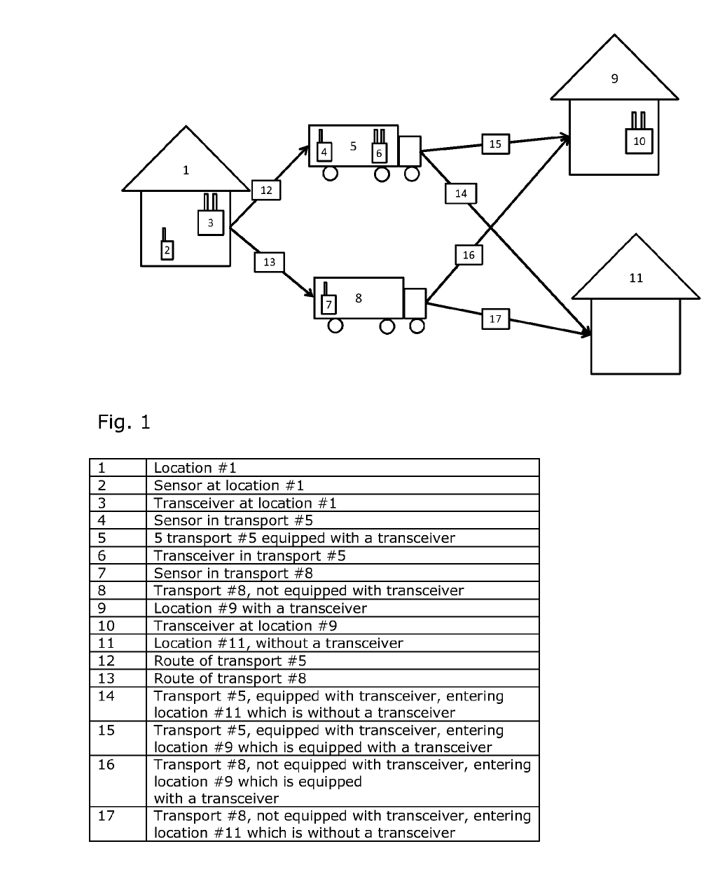

FIG. 1 shows different possibilities of transportation in an “on-line” distribution monitoring system. Although some, or even all, of the loggers being transported have an external communication module to communicate through a mobile network it is important to address the case where the loggers have lost the ability to communicate through the external module.

One transport vehicle is equipped with a transceiver, and by utilizing that transceiver and information stored in the centralized system, the monitoring of shipment and automatic closure can be performed both when a transceiver is positioned at the destination location and also where there is no transceiver at the destination location.

The other transport vehicle is not equipped with a network connected transceiver. The user can know when a shipment has arrived at the destination location only when a transceiver is positioned there. When that transport arrives to a location which is not equipped with a network connected transceiver, there is no way of the owner of the shipment to know the condition of the shipment from the wireless active logger in the shipment. Although it provides multiple benefits, it is at these places in the distribution network where the present invention will be utilized to its fullest extent.

A company, for example in the ground transportation logistic industry, is distributing perishable goods in containers to multiple locations. It is vital for the company to be able to log environmental condition of containers during transportation to ensure proper service to its customers. Previously the company has used offline loggers, which had to be connected to a computer to offload data from. A large number of products are being sent each day to a large number of destinations. The frequency of shipments to each location is irregular and the content of the shipment may also vary significantly between shipments. Due to the cost of loggers, manpower needed to offload and process data and other logistics issues the company is forced to select only the shipment of the most value to monitor. It is impossible for the company to monitor every shipment of the chain with offline loggers without introducing too much cost to end customers.

Introducing an on-line infrastructure is costly since a means to deliver the logged data to a centralized system must be present at desired locations in the distribution chain, more specifically during transport if real time monitoring is necessary, and/or at the destination location. It is clear that to acquire the logged data once the shipment arrives at the destination location and to deliver it to a centralized database, there is a need of infrastructure to do so.

In the case of the company, many of the locations are of such importance and receive so many shipments of much value that it pays off for it to install a transceiver at such locations to ensure automatic delivery of data to the centralized system and to validate the delivery once shipment arrives there. In other cases, where transportation is managed by the company itself, it will install infrastructure into transport vehicles so that delivery of data is ensured during transportation and to delivery.

Looking at FIG. 1, where at the distributors warehouse (1) there is a transceiver (3) to ensure connection of sensor (i.e. 2) to the centralized system. Once a shipment, equipped with a wireless active logger (4) enters a transport vehicle (5), the wireless active logger begins to send data through the transceiver (6) in the vehicle. During transportation (12) data is sent through the transceiver (6) and upon delivery (15) to location (9) the wireless active logger begins to send data through the transceiver (10) at the location (9). The company can therefore see whether or not the shipment was within desired environmental boundaries during shipment. In the event that the same transportation vehicle (5) enters another location (14) which is not equipped with a transceiver, the centralized system has gathered information on the condition during transportation and up to delivery. Therefore the company can see whether or not the shipment was within desired environmental conditions during transportation.

In the case where a vehicle (8) has a shipment equipped with a wireless active logger (7) but no transceiver, there is no way of knowing environmental conditions of the shipment during transport (13), unless the shipment comes within the vicinity of a transceiver at some points during transport. When the shipment is delivered (16) to a location (9) which is equipped with a transceiver (10) the data from the wireless active logger is transmitted through the transceiver (10) to the centralized system. The company will therefore know whether or not the environmental conditions during transportation were within desired limits. If the same vehicle (8) transports the shipment (17) to location (11) which is not equipped with a transceiver, there is no way for the company to know the environmental conditions in an automatic manner. The data, stored in the wireless active logger, will either have to be offloaded manually by connecting it to a computer or by coming into the vicinity of a transceiver which will then deliver the data automatically to the centralized system—but that would require the recipient to send the wireless active logger to a location equipped with a transceiver.

With the present invention the recipient, at a location without a transceiver, of a product which was transported by a vehicle which was not equipped with a transceiver can connect the wireless active logger to a computer to transport data to the centralized system and furthermore transform the wireless active logger into an active transceiver with the purpose of atomizing the delivery of data to the centralized system for future shipments.

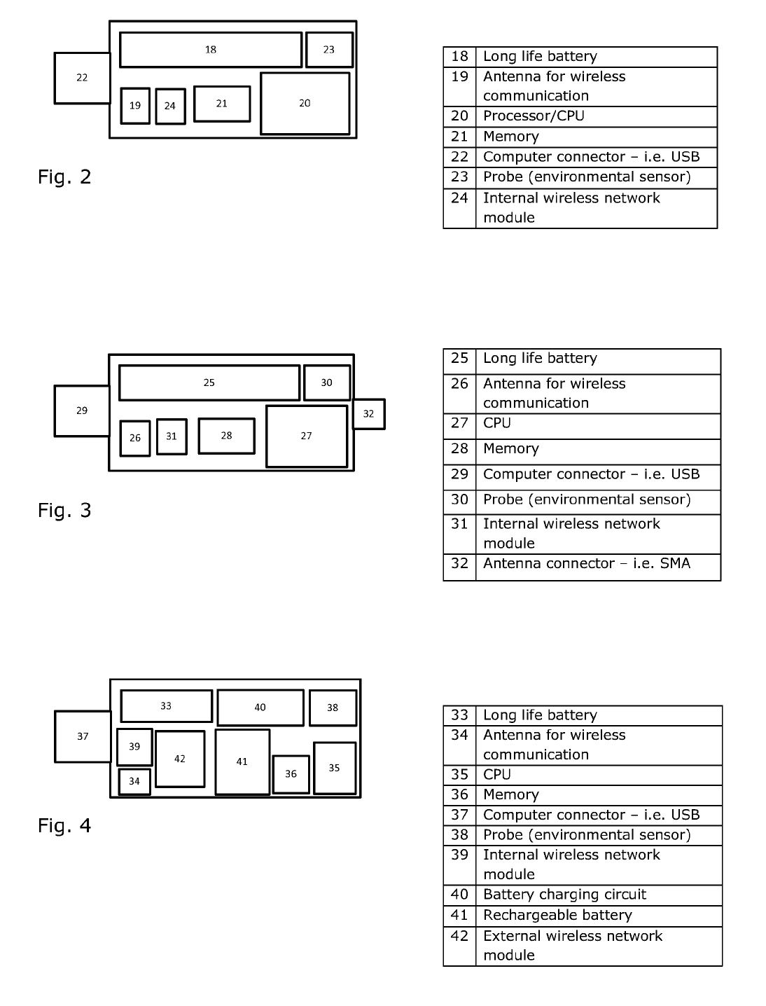

FIG. 2 shows the wireless active logger, containing a long-life/low-power battery (18), central processing unit (20), memory (21), antenna (19), environmental sensor (23), communication/data transmit port (22) and an internal wireless network module (24).

During transportation, the processor (20) operates the wireless active logger and ensures that measurements are taken on a regular basis by the sensor (23) and stored in memory (21). When in connection with a transceiver through its internal wireless network module (24), both data stored in memory and real-time data is sent to the centralized system. The battery (18) supplies the wireless active logger with energy to operate during transportation. When in connection to a computer via a computer connector (22) the data is communicated through the connector to the computer where software sends the data to a centralized system.

FIG. 3 shows the device, containing a long-life/low-power battery (25), central processing unit (27), memory (28), antenna (26), an environmental sensor (30), internal wireless network module (31), communication/data transmit port (29) and an antenna connector (32).

FIG. 4 shows the device, containing a long-life/low-power battery (33), central processing unit (35), memory (36), antenna (34), an environmental sensor (38), internal wireless network module (39), external wireless network module (42) to communicate to a network (i.e. internet, VPN etc), communication/data transmit port (37), rechargeable battery (41) and a recharging circuit (40).

During transportation, the processor (35) operates the wireless active logger and ensures that measurements are taken on a regular basis by the sensor (38) and stored in memory (36). When in connection with a transceiver, both data stored in memory and real-time data is sent to a transceiver through the internal wireless network module and from there to the centralized system. The battery (33) supplies the wireless active logger with energy to operate during transportation. When in connection to a computer via a computer connector (37) the data is communicated through the connector to the computer where software sends the data to a centralized system. When not in connection to a computer, the wireless active logger can communicate data to the centralized system via an external wireless network module (42). During communication with the centralized system, the wireless active logger will use its rechargeable battery (41) to power the external wireless network module (42). In the event that the wireless active logger is in the vicinity of a network connected transceiver, the wireless active logger will stop to use its wireless network communication module to communicate and start to operate only on its long-life/low-power battery (33) and reporting measurements to the present transceiver through its internal wireless network module (39). The rechargeable battery (41) will be recharged by the recharging circuit (40) once connected to a computer with a computer connector (37) long-life/low-power battery (43), a CPU (45), memory (46), antenna (44), an environmental sensor (47), internal wireless network module (39), external wireless network module (42) to communicate to a network (i.e. internet, VPN etc), communication/data transmit port (37), rechargeable battery (41) and a recharging circuit (40).

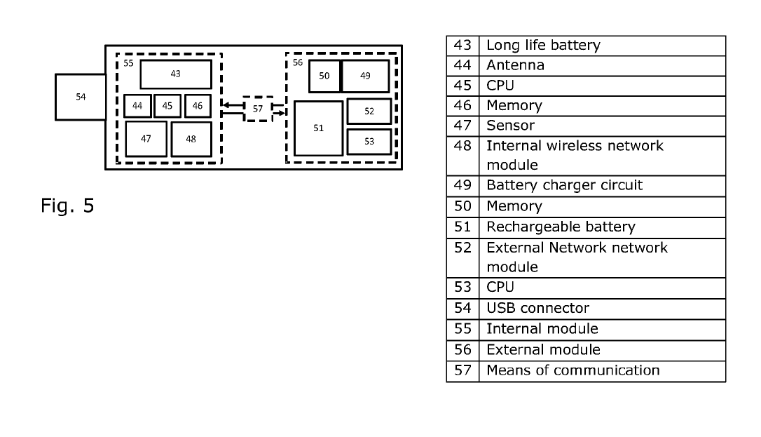

FIG. 5 shows a device as disclosed in claim 1, containing two separate modules, the internal low power measurement and communication module (55) and the external communication module (56). The low power internal module (55) consists of a long-life/low-power battery (43), a CPU (45), memory (46), antenna (44), an environmental sensor (47), internal wireless network module (48). The external communication module (14) consists of a battery charging circuit (49), memory (50), rechargeable battery (51), external network module (52) and a CPU (53). These modules are equipped with means to communicate with each other (57), both data on the current state (i.e. current battery level, connectivity to external networks etc.) and measurements and other information which needs to be transferred to the centralized system. During transportation, the internal module (55) continuously (once every few seconds, minutes or hours) takes measurements and stores in memory. The long-life battery (43) is capable of supporting this measurement capability for a long period of time (many years). On a regular basis (every few minutes, hours or days) the logger will start the external module (56) and try to send the data through the current network, if a connection can be made. If a connection can be made, the logger will communicate its data to the centralized system. After that, the external module will go to low-power mode, spending little-to-no energy in that state, until it is time to send data again. The internal module can decide, due to various reasons (i.e. if temperature is going out of defined bounds in a shipment), to start the external module for immediate transfer of data to the centralized system. If the rechargeable battery (51) has not enough capacity to power the external module, the internal module will continue to measure and store measurement data in memory. Once the charging circuit (49) has power again, the device will start to send data to the centralized system. If the charging circuit does not get power, the internal module will continue to measure and store measurements in memory until; a) the logger gets into the vicinity of a network connected transceiver, where if that happens the logger will transmit its measured data to the centralised system and delivery validation is performed, if relevant, or b) the logger is connected to a network connected computer via a computer connector (USB, FireWire, Lan or other), where if that happens software in the computer will download data from the logger and send it to the centralised system.

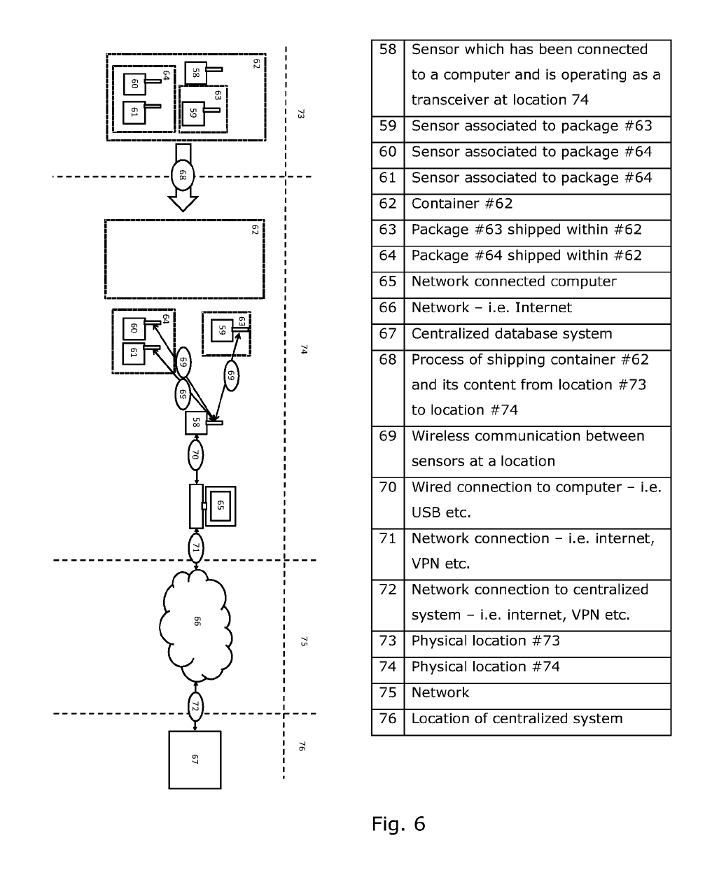

FIG. 6 shows how a single wireless active logger from a shipment of many can be connected to a network connected computer and delivers logged measurement data via direct connection to the computer, both its own data straight from memory and data from other wireless active loggers over a wireless connection.

A shipment, (62) containing one or many containers (63 and 64) where one or more wireless active loggers are placed within a container, is shipped (68) through a distribution network to the destination location (74). During transportation, the wireless active loggers log measurements in memory. Once the shipment arrives at its destination location (74) the user will take one wireless active logger, the present invention, and connect it (71) to a computer (65). With the correct software set up on the computer (65) the connected wireless active logger (58) will start to operate as a transceiver and data will be transported wirelessly (69) from wireless active loggers(59,60 and 61) within the vicinity of the connected wireless active logger (58). The data will be transported through a network connection (71) onto a network (66/75) and to the centralized system (67/76).

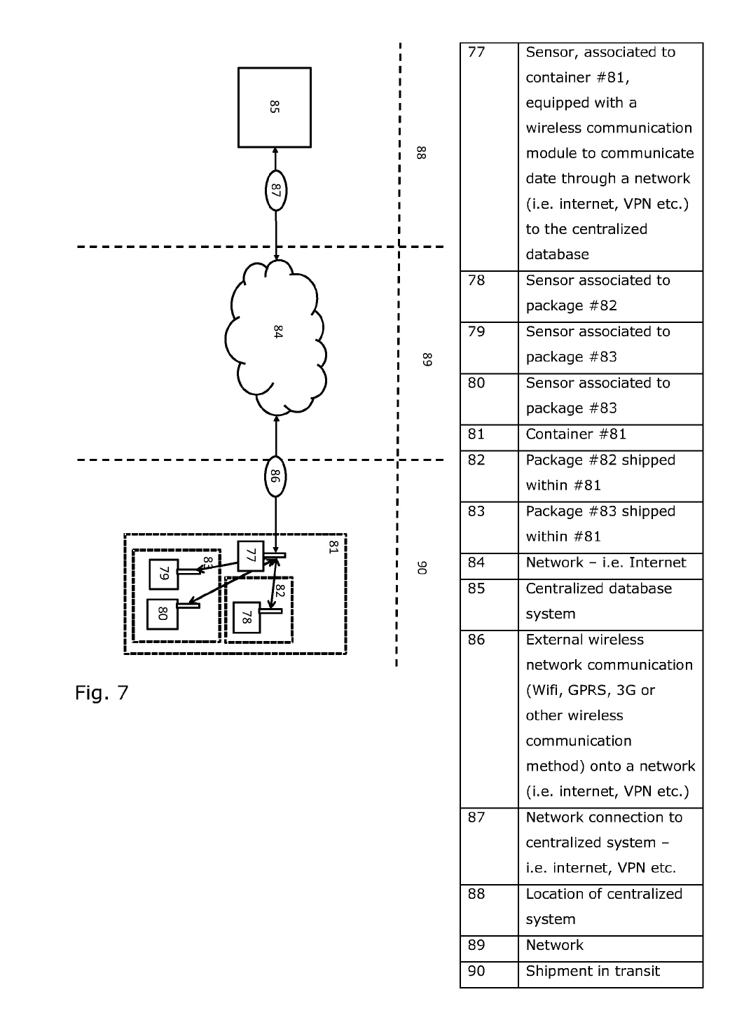

FIG. 7 shows how a single wireless active logger, equipped with a wireless communication module to communicate to the centralized system through a network, communicates information from multiple wireless active loggers to the centralized system during transport.

The present invention can operate as a transceiver during transport. It will, in that case, be equipped with an external wireless network connection to communicate with a network.

A shipment, (81) containing one or many containers (82 and 83) where one or more wireless active loggers are placed within a container. During transport (90) it can send data (86) from all wireless active loggers in the vicinity of it, i.e. in the same shipment, through a network (84/89) and into the centralized system (85).

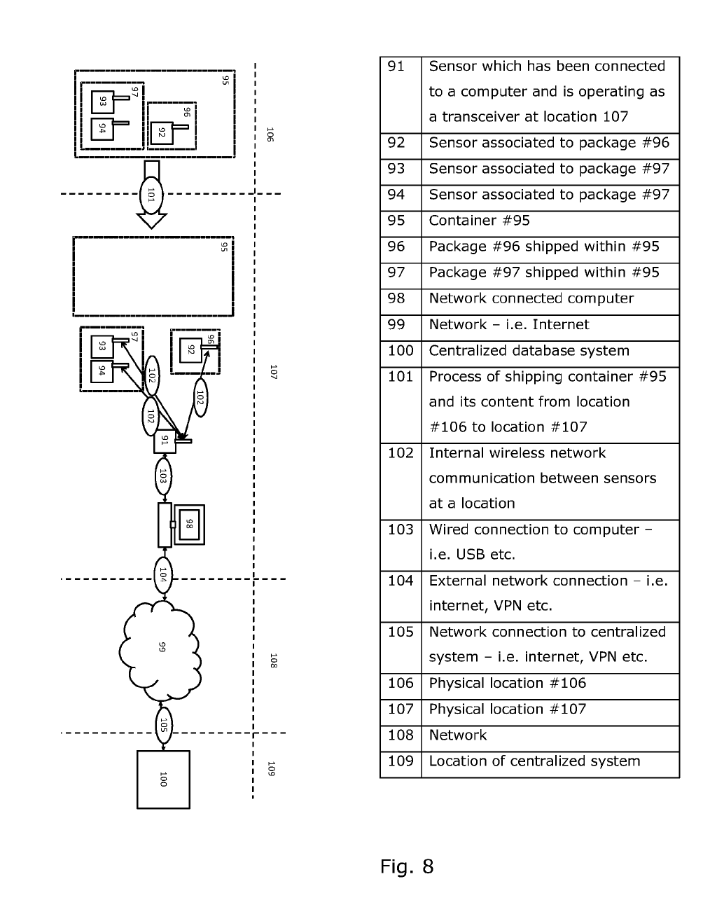

FIG. 8 shows a single wireless active logger connected to a computer at a location and how it serves as a transceiver to communicate both its own data straight from memory and data from arriving wireless active loggers to the centralized system

A shipment, (95) containing one or many containers (96 and 97) where one or more wireless active loggers are placed within a container, is shipped (101) through a distribution network to the destination location (107). During transportation, the wireless active loggers log measurements in memory. Once the shipment arrives at its destination location (107) the wireless active loggers will connect to a wireless active logger which is connected to a computer and is operating as a transceiver. With the correct software set up on the computer (8) the connected wireless active logger (91) operates as a transceiver and data will be transported wirelessly (102) from wireless active loggers(92, 93 and 94) within the vicinity of the connected wireless active logger (91). The data will be transported through a network connection (104) onto a network (99/108) and to the centralized system (100/109).

### EXAMPLES

### Example 1

A company transporting large quantities of perishable goods to a limited number of customers will install a relatively costly “on-line” infrastructure to each of these locations.

The company also delivers a limited amount of products to a few hundred customers which are located in the distribution network operated by the company. For that case, the company will invest in an “on-line” infrastructure in every transport vehicle.

The company however ships thousands of valuable packages to customers all over the world, both on a regular and irregular basis. The company needs to get a validation of a successful shipment upon delivery, but sponsoring and building up an infrastructure with live “on-line” transceivers is way too costly.

The present invention will solve this scenario as the delivered wireless active logger itself will start to operate as a transceiver, once connected to a network connected computer and installation of software, thus serving as an important factor in the entire distribution network.

### Example 2

A company doing research for a new medicine requires multiple test subjects to receive medicine on a regular basis, in different areas of the world. To ensure correct research data, all shipments must be monitored. Test subjects must ensure delivery of log-data to researchers. Furthermore, the test subjects must monitor medicine while in their storage, throughout the research period.

The present invention solves this scenario with logging of data, automatic delivery of data to a centralized system—only by connecting logger to a network connected computer. If the researching company sends a pair of wireless active loggers where one can serve as a transceiver for the wireless active logger used for monitoring the medicine during the research trial.

### Example 3

Solving what is described in example 2 the present invention can furthermore monitor the medicine during transportation, if the wireless active logger is equipped with an external wireless network module for communicating to the centralized system.

1. A wireless active logger for measuring and storing information on environmental conditions during transportation comprising:
a. an internal low power module comprising:
i. a memory
ii. a processor
iii. a sensor
iv. an internal wireless network module
v. a long life battery
b. an external module comprising:
i. a memory
ii. a rechargeable battery
iii. a charging circuit
iv. an external network module
v. a processor
c. means of internal communication between the two modules, and
d. means of communicating with a computer,
wherein the internal low power module continuously logs data from the sensor and sends the data to a centralized system through the external module, when the external module is in communication with a wireless network.

2-6. (canceled)

7. The wireless active logger according to claim 1, wherein the wireless active logger comprises means to communicate log data and other information from the wireless active logger itself and other wireless active loggers in the vicinity of it directly to a centralized system.

8. The wireless active logger according to claim 7, wherein the wireless active logger initiates communication only when the sensor obtains environmental measurements out of a set measurement limit for the environmental conditions.

9. The wireless active logger according to claim 1, wherein the wireless active logger is powered by a computer connector.

10. The wireless active logger according to claim 1, wherein computer software is used for communicating data from the wireless active logger through a computer connector to a centralized system via a network connection.

11. The wireless active logger according to claim 10, wherein the computer software is stored in the wireless active logger.

12. The wireless active logger according to claim 10, wherein the computer software is stored on the computer into which the wireless active logger is connected to for communicating the data to the centralized system.

13. The wireless active logger according claim 10, wherein the software provides a unique location identification number which the centralized system uses to identify from which location data is being sent.

14. The wireless active logger according to claim 1, wherein the wireless active logger further comprises an antenna.

15. The wireless active logger according to claim 10, wherein the computer connector is a data and power connection to a computer via a USB connector, a FireWire connector or a wireless connected dock station.

16. The wireless active logger according to claim 1, wherein the sensor detects environmental conditions such as temperature, humidity and light intensity.

17. A system for measuring and storing information on environmental conditions during transportation, the system comprising providing a wireless active logger, said wireless active logger further comprising:
a. an internal low power module comprising:
i. a memory
ii. a processor
iii. a sensor
iv. an internal wireless network module
v. a long life battery
b. external module comprising:
i. a memory
ii. a rechargeable battery
iii. a charging circuit
iv. an external network module
v. a processor
c. means of internal communication between the two modules, and
d. means of communicating with a computer,
wherein the internal low power module continuously logs data from the sensor and sends the data to a centralized system through the external module, when the external module is in communication with a wireless network.

18. The system according to claim 17, wherein the internal low power module continuously logs data from the sensor after the rechargeable battery has run out.

19. The system according to claim 17, wherein the wireless active logger sends the data to a centralized system through the external module while the rechargeable battery has charge.

20. The system according to claim 17, wherein the wireless active logger communicates with a transceiver at a destination location via the internal low power module to:
a. verify that it has arrived to the destination location, or
b. communicate measurements and other information to the centralized system.

21. The system according to claim 20, wherein the wireless active logger can be connected to a computer at the destination location to:
a. communicate data from the logger to the centralized system in case of failure in the logger, connection problems or low battery charge, or
b. serve as a transceiver.

22. The system according to claim 17, wherein the wireless active logger communicates wirelessly with a transceiver which is assigned to it when it is in the vicinity of such a transceiver.

23-29. (canceled)

30. The system according to claim 17, wherein the wireless active logger will not use its external wireless network modules when the sensors are in the vicinity of an active transceiver.

31. The system according to claim 17, wherein the wireless active logger does not collect data from other wireless active loggers in the vicinity of itself if it cannot establish a connection or re-establish a lost connection to the centralized system.

32. The system according to claim 17, wherein the external wireless communication module initiates communication with the centralized system before, during and after transportation if the external wireless communication module embedded in the wireless logger is connected to a wireless network.
